(19) United States
(12) Patent Application Publication
(10) Pub. No.: US 2020/0131349 A1
(43) Pub. Date: Apr. 30, 2020

(54) USE OF VULCANIZABLE COMPOSITIONS AND VULCANIZATES IN CONTACT WITH COOLANT, COMPRISING SILANE-COATED WOLLASTONITE

(71) Applicant: ARLANXEO Deutschland GmbH, Dormagen (DE)

(72) Inventors: Ulrich FRENZEL, Dormagen (DE); Susanna LIEBER, Kaiserslautern (DE)

(73) Assignee: ARLANXEO Deutschland GmbH, Dormagen (DE)

(21) Appl. No.: 16/305,249

(22) PCT Filed: May 31, 2017
(86) PCT No.: PCT/EP2017/063177

§ 371 Date: Nov. 28, 2018

(30) Foreign Application Priority Data
Jun. 7, 2016 (EP) 16001280.3

(51) Int. Cl. C08L 15/00; C08K 5/14; C08K 9/06; C08K 3/04; C08K 3/34; B29C 35/16

(52) U.S. Cl. CPC C08L 15/005; C08K 5/14; C08K 9/06; B29C 2035/1616; C08K 3/34; B29C 35/16; C08K 3/04

(57) ABSTRACT

The present invention relates to a process for producing a vulcanizate which is in contact with coolant and to the use of a vulcanizable composition comprising rubber, silane-coated wollastonite and peroxide compound for production of vulcanizates in contact with coolant.

The invention further relates to a process for production and to the use of a vulcanizate produced from a vulcanizable composition comprising rubber, silane-coated wollastonite and peroxide compound as a component part, preferably as a seal or as a hose, in contact with coolant.

The present invention relates to a process for producing a vulcanizate which is in contact with coolant and to the use of a vulcanizable composition comprising rubber, silane-coated wollastonite and peroxide compound for production of vulcanizates in contact with coolant.

The invention further relates to a process for production and to the use of a vulcanizate produced from a vulcanizable composition comprising rubber, silane-coated wollastonite and peroxide compound as a component part, preferably as a seal or as a hose, in contact with coolant.

The demands on vulcanizates for use as cooler hose, heating hose, cooler housing or cooler seal are ever-increasing. Thus, for fulfilment of safety standards, suitable vulcanizates must have sufficient ageing stability both in hot air and in coolant, i.e. a change of 25% or less in elongation at break after 21 days (504 hours) at 150° C. in hot air and a change of 25% or less in elongation at break after 21 days (504 hours) at 150C in coolant.

The person skilled in the art understands coolant to mean a liquid substance or substance mixture which is used to transport heat away. The coolant is capable of transporting the enthalpy along the temperature gradient to a site at lower temperature in a cooling cycle. Cooling liquids can cool the material to be cooled directly or via a heat exchanger.

In the context of this invention, coolants are compositions comprising water, a freezing point depressant, preferably alkylglycol or salts, more preferably ethylene glycol or propylene glycol, and a corrosion inhibitor, preferably neutralized organic acids, more preferably sodium ethylhexanoate.

In conventional coolants, silicates were formerly used as additive. The silicate does prevent corrosion by forming a protective aluminium silicate layer on aluminium parts, but it degrades rapidly and therefore has to be renewed regularly. Newer generations of coolant therefore contain, in place of the silicate, organic compounds for corrosion protection, since these last for longer.

For a while, what is called OAT (organic acid technology) has been used in coolants.

In this technology, neutralized organic acids, for example sodium ethylhexanoate, are being used as additive. At elevated temperature, however, over the course of time, the salt of ethylhexanoic acid gives the free acid. This acid can lead to premature ageing in the case of conventional vulcanizates. One example of a coolant concentrate with OAT technology is G13 from Volkswagen, which comprises ethylene glycol and sodium ethylhexanoate as main components, and, blended with water, gives a coolant according to the invention.

There is thus a demand for vulcanizates which meet high demands on ageing stability both in hot air and in coolants. More particularly, high ageing stability is desirable in those coolants that include large amounts of organic acids, for example 2-ethylhexanoic acid or sebacic acid. Furthermore, the further typical rubber properties, for instance tensile strength, elongation and compression set, have to be sufficiently good compared to conventional standard types.

WO-A-2010/030860 discloses, in examples 2 and 3, a vulcanizable composition based on hydrogenated nitrile rubber (HNBR) comprising silane-coated wollastonite (400 Wollastocoat 10022), an acid acceptor, a metal salt and a stabilizer. This composition has rapid vulcanization and improved processibility, heat stability and a low compression set. The composition of example 3 additionally also has reduced and hence improved swelling in water. WO-A-2010/030860, both in the compositions of example 2 and in example 3, includes not only the silane-coated wollastonite but also zinc oxide (ZnO) and Therban HT. In other words, the use of vulcanizable compositions comprising HNBR and silane-coated wollastonite in combination with a metal salt and an acid acceptor is described for increasing ageing stability. WO-A-2010/030860 does not give any pointer to the use of the vulcanizable composition and vulcanizates thereof in contact with coolant and the stability thereof to coolants.

WO-A-2015/146862 discloses HNBR compositions containing 3 to 20 phr of wollastonite and 72 to 87 phr of carbon black for abrasion resistance and compressive strength. The use of these compositions in contact with coolants and the swelling characteristics thereof are not disclosed.

CN-A-103408810 discloses a seal based on a composition comprising, inter alia, nitrile rubber (NBR) and modified wollastonite with improved mechanical properties and improved abrasion resistance and thermal stability. The use of this composition in contact with coolants and the swelling characteristics thereof are not disclosed.

KR20130003554 discloses a sealing composition comprising HNBR and ethylene glycol as antifreeze additive. Silane-coated wollastonite is not disclosed.

A common factor among all prior art documents is that there are no known vulcanizable compositions based on HNBR that meet the current high demands for use in contact with coolants.

The problem addressed by the present invention was thus that of providing vulcanizable compositions and processes for producing vulcanizates having ageing stability in the form of a change of 25% or less in the elongation at break after 21 days (504 hours) at 150° C. in hot air and a change of 25% or less in the elongation at break after 21 days (504 hours) at 150° C. in coolant, and hence can be used in contact with coolants with OAT technology.

A further problem addressed is that of providing preferably those vulcanizable compositions and processes that lead to vulcanizates having comparable or improved swelling in coolants compared to vulcanizable compositions of the prior art.

A further problem addressed is that of providing especially preferably those vulcanizable compositions and processes that lead to vulcanizates additionally having a Shore A hardness of less than 70, in order that the material is sufficiently elastic.

It has been found that, surprisingly, combination of rubber with silane-coated wollastonite and peroxide compounds affords compositions that lead to vulcanizates which satisfy the requirements mentioned and hence are suitable for use in contact with coolants.

The invention provides for the use of a vulcanizable composition for production of a vulcanizate in contact with coolant, characterized in that the vulcanizable composition comprises
(a) at least one rubber, preferably at least one hydrogenated nitrile rubber or EPDM, more preferably hydrogenated nitrile rubber,
(b) at least one silane-coated wollastonite, preferably at least one vinylsilane-coated wollastonite, and
(c) at least one peroxide compound.

The invention thus also provides processes for producing a vulcanizate in contact with coolant, comprising the step of vulcanizing a vulcanizable composition, characterized in that the vulcanizable composition comprises
(a) at least one rubber, preferably at least one hydrogenated nitrile rubber or EPDM, more preferably hydrogenated nitrile rubber,
(b) at least one silane-coated wollastonite, preferably at least one vinylsilane-coated wollastonite, and
(c) at least one peroxide compound.

This solution was surprising in that not every vulcanizable composition that was already known for good ageing stability or good coolant stability is suitable for the high demands on the use of vulcanizates in contact with coolant.

The effect of the use of vulcanizable compositions and vulcanizates thereof and processes for production thereof according to the present invention is that the components produced from the vulcanizates have lower ageing than conventional vulcanizates without silane-coated wollastonite.

Preference is given to the use of a vulcanizable composition for production of a vulcanizate in contact with coolant and to a process for producing a vulcanizate, characterized in that the vulcanizable composition comprises
(a) 100 parts by weight of at least one rubber, especially hydrogenated nitrile rubber or EPDM, more preferably hydrogenated nitrile rubber,
(b) 35 to 150 parts by weight, preferably 50 to 100 parts by weight, of at least one silane-coated wollastonite, especially epoxysilane-, methacryloylsilane- or vinylsilane-coated wollastonite or mixtures thereof,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide or aluminium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the rubbers (a).

Particular preference is given to the use of vulcanizable compositions for production of a vulcanizate in contact with coolant and to a process for producing a vulcanizate in contact with coolant, comprising the step of vulcanizing a vulcanizable composition comprising
(a) 100 parts by weight of a hydrogenated nitrile rubber,
(b) 35 to 150 parts by weight, preferably 50 to 100 parts by weight, of at least one silane-coated wollastonite, especially epoxysilane-, methacryloylsilane- or vinylsilane-coated wollastonite or mixtures thereof,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide or aluminium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids.

The effect of the inventive use of the vulcanizable compositions and an inventive process for producing a vulcanizate in contact with coolant is that comparably low swelling of the vulcanizate in the coolant and a smaller change in the expansion of the vulcanizate on storage in hot air and coolant occurs compared to known vulcanizable compositions.

At least one typical rubber is used as component (a). Rubber as component (a) is, for example, nitrile rubber (NBR), hydrogenated nitrile rubber (HNBR), ethylene-propylene rubber (EPM), ethylene-propylene-diene rubber (EPDM), ethylene-vinyl acetate (EVA; EVM), natural rubber (NR), chloroprene rubber (BR), butyl rubber (IIR), polyisoprene rubber (IR), styrene-butadiene rubber (SBR), chloroprene rubber (CR), ethylene-acrylate rubber (AEM) or acrylate rubber (ACM), and any desired mixtures of the aforementioned rubbers.

The use of hydrogenated nitrile rubber, EPM or EPDM as component (a) is preferred.

The use of hydrogenated nitrile rubber as component (a) is particularly preferred.

It is also possible to use a blend of hydrogenated nitrile rubber with ethylene-vinyl acetate rubber, preferably with replacement of up to 20 parts HNBR with the same amount of EVM.

The Mooney viscosity (ML 1+4 measured at 100° C.) of the rubber (a) used or, if two or more rubbers (a) are used, of the overall mixture of all rubbers (a) is within a range from 10 to 120, preferably within a range from 20 to 110, more preferably within a range from 30 to 100. The Mooney viscosity is determined here to ASTM Standard D 1646.

Some of the rubbers (a) mentioned are commercially available, but are also obtainable in all cases by production methods accessible to the person skilled in the art via the literature.

Hydrogenated nitrile rubbers (HNBRs) in the context of this application are understood to mean co- and/or terpolymers based on at least one conjugated diene and at least one α,β-unsaturated nitrile monomer and optionally further copolymerizable monomers, where all or some of the copolymerizable diene units have been hydrogenated.

“Hydrogenation” or “hydrogenated” in the context of this application is understood to mean a conversion of the double bonds originally present in the nitrile rubber to an extent of at least 50%, preferably at least 85%, more preferably at least 95%.

The α,β-unsaturated nitrile used may be any known α,β-unsaturated nitrile, preference being given to (C₃-C₅)-α,β-unsaturated nitriles such as acrylonitrile, methacrylonitrile, ethacrylonitrile or mixtures thereof. Acrylonitrile is particularly preferred.

Any conjugated diene can be used. Preference is given to using (C₄-C₆) conjugated dienes. Particular preference is given to 1,3-butadiene, isoprene, 2,3-dimethylbutadiene, piperylene or mixtures thereof. Especially preferred are 1,3-butadiene and isoprene or mixtures thereof. Very particular preference is given to 1,3-butadiene.

The proportions of conjugated diene and α,β-unsaturated nitrile in the hydrogenated nitrile rubbers can be varied within wide ranges. The proportion of, or of the sum of, the conjugated dienes is typically in the range from 40% to 90% by weight, preferably in the range from 50% to 80% by weight, based on the overall polymer. The proportion of, or of the sum of, the α,β-unsaturated nitriles is typically in the range from 10% to 60% by weight, preferably in the range from 20% to 50% by weight, based on the overall polymer. The additional monomers may be present in amounts in the range from 0.1% to 40% by weight, preferably in the range from 1% to 30% by weight, based on the overall polymer. In this case, corresponding proportions of the conjugated diene(s) and/or of the α,β-unsaturated nitrile(s) are replaced by the proportions of the additional monomers, where the proportions of all monomers in each case add up to 100% by weight.

The preparation of such hydrogenated nitrile rubbers that are suitable for the vulcanizable compositions according to the invention is sufficiently familiar to the person skilled in the art.

The initial preparation of the nitrile rubbers by polymerization of the aforementioned monomers has been described extensively in the literature (e.g. Houben-Weyl, Methoden der Organischen Chemie [Methods of Organic Chemistry], vol. 14/1, Georg Thieme Verlag Stuttgart 1961).

The subsequent hydrogenation of the above-described nitrile rubbers to hydrogenated nitrile rubber can be effected in the manner known to the person skilled in the art.

It is possible in principle to conduct the hydrogenation of nitrile rubbers using homogeneous or heterogeneous hydrogenation catalysts.

As described in WO-A-01/77185, it is possible, for example, to conduct the reaction with hydrogen using homogeneous catalysts, for example that known as the “Wilkinson” catalyst ((PPh₃)₃RhCl) or others. Processes for hydrogenating nitrile rubber are known. Rhodium or titanium are typically used as catalysts, but it is also possible to use platinum, iridium, palladium, rhenium, ruthenium, osmium, cobalt or copper, either as the metal or else preferably in the form of metal compounds (see, for example, U.S. Pat. No. 3,700,637, DE-A-25 39 132, EP-A-134 023, DE-A-35 41 689, DE-A-35 40 918, EP-A-298 386, DE-A-35 29 252, DE-A-34 33 392, U.S. Pat. Nos. 4,464,515 and 4,503,196).

Suitable catalysts and solvents for a hydrogenation in homogeneous phase are described hereinafter and are also known from DE-A-25 39 132 and EP-A-0 471 250.

The selective hydrogenation can be achieved, for example, in the presence of a rhodium catalyst. It is possible to use, for example, a catalyst of the general formula

(R¹ₘB)ₗRhXₙ

in which
R¹ is the same or different and is a C₁-C₈ alkyl group, a C₄-C₈ cycloalkyl group, a C₆-C₁₅ aryl group or a C₇-C₁₅ aralkyl group,
B is phosphorus, arsenic, sulphur or a sulphoxide group S═O,
X is hydrogen or an anion, preferably halogen and more preferably chlorine or bromine,
l is 2, 3 or 4
m is 2 or 3 and
n is 1, 2 or 3, preferably 1 or 3.

Preferred catalysts are tris(triphenylphosphine)rhodium(I) chloride, tris(triphenylphosphine)rhodium(III) chloride and tris(dimethyl sulphoxide)rhodium(III) chloride, and also tetrakis(triphenylphosphine)rhodium hydride of the formula ((C₆H₅)₃P)₄RhH and the corresponding compounds in which the triphenylphosphine has been replaced fully or partly by tricyclohexylphosphine. The catalyst can be used in small amounts. An amount in the range of 0.01% to 1% by weight, preferably in the range of 0.03% to 0.5% by weight and more preferably in the range of 0.1% to 0.3% by weight, based on the weight of the polymer, is suitable.

It is typically advisable to use the catalyst together with a cocatalyst which is a ligand of the formula R¹ₘB where R¹, m and B are each as defined above for the catalyst. Preferably, m is 3, B is phosphorus and the R¹ radicals may be the same or different. Preference is given to cocatalysts having trialkyl, tricycloalkyl, triaryl, triaralkyl, diarylmonoalkyl, diarylmonocycloalkyl, dialkylmonoaryl, dialkylmonocycloalkyl, dicycloalkylmonoaryl or dicycloalkylmonoaryl radicals.

Examples of cocatalysts can be found, for example, in U.S. Pat. No. 4,631,315. A preferred cocatalyst is triphenylphosphine. The cocatalyst is used preferably in amounts within a range of 0.3% to 5% by weight, more preferably in the range of 0.5% to 4% by weight, based on the weight of the nitrile rubber to be hydrogenated. Preferably, in addition, the weight ratio of the rhodium catalyst to the cocatalyst is in the range from 1:3 to 1:55, more preferably in the range from 1:5 to 1:45. Based on 100 parts by weight of the nitrile rubber to be hydrogenated, in a suitable manner, 0.1 to 33 parts by weight of the cocatalyst, preferably 0.5 to 20 and most preferably 1 to 5 parts by weight, especially more than 2 but less than 5 parts by weight, of the cocatalyst are used, based on 100 parts by weight of the nitrile rubber to be hydrogenated.

The practical performance of such hydrogenations is sufficiently well known to those skilled in the art, for example from U.S. Pat. No. 6,683,136. It is typically effected by contacting the nitrile rubber to be hydrogenated with hydrogen in a solvent such as toluene or monochlorobenzene at a temperature in the range from 100° C. to 150° C. and a pressure in the range from 50 bar to 150 bar for 2 hours to 10 hours.

In the case of use of heterogeneous catalysts for preparation of hydrogenated nitrile rubbers by hydrogenation of the corresponding nitrile rubbers, the catalysts are typically supported catalysts based on palladium.

The Mooney viscosity (ML 1+4 measured at 100° C.) of the hydrogenated nitrile rubber (a) used or, if two or more hydrogenated nitrile rubbers (a) are used, of the overall mixture of all hydrogenated nitrile rubbers (a) is within a range from 10 to 120, preferably within a range from 15 to 100. The Mooney viscosity is determined here to ASTM Standard D 1646.

The hydrogenated nitrile rubber according to the invention has a residual double bond content (RDB) of 10% or less, preferably of 7% or less, more preferably of 1% or less.

The hydrogenated nitrile rubbers usable in the vulcanizable composition according to the invention have a glass transition temperature of less than −10° C., preferably less than −15° C., more preferably less than −20° C., measured via DSC at a heating rate of 20 K/min.

Examples of commercially available hydrogenated nitrile rubbers are fully and partly hydrogenated nitrile rubbers having acrylonitrile contents in the range of 17% to 50% by weight (Therban range from ARLANXEO Deutschland GmbH and Zetpol® range from Nippon Zeon Corporation). One example of hydrogenated butadiene/acrylonitrile/acrylate polymers is the Therban® LT series from ARLANXEO Deutschland GmbH, for example Therban® LT 1707 VP, Therban® LT 2157 and Therban® LT 2007. One example of carboxylated hydrogenated nitrile rubbers is the Therban® XT series from ARLANXEO Deutschland GmbH. One example of hydrogenated nitrile rubbers having low Mooney viscosities and therefore improved processibility is a product from the Therban® AT series, for example Therban® AT 3404.

The hydrogenated nitrile rubber, as well as repeat units of at least one unsaturated nitrile and at least one conjugated diene, may contain one or more further copolymerizable monomers in the form of carboxylic acids or carboxylic esters.

Suitable copolymerizable carboxylic acids are mono- or dicarboxylic acids which have 3 to 18 carbon atoms and are α,β-unsaturated, and esters thereof. Preferred α,β-unsaturated carboxylic acids are acrylic acid, methacrylic acid, itaconic acid, fumaric acid, maleic acid, crotonic acid and mixtures thereof.

Esters of the α,β-unsaturated carboxylic acids having 3 to 18 carbon atoms preferably include the alkyl esters and the alkoxyalkyl esters of the aforementioned carboxylic acids. Preferred esters of the α,β-unsaturated carboxylic acids having 3 to 18 carbon atoms are methyl acrylate, ethyl acrylate, butyl acrylate, 2-ethylhexyl acrylate, octyl acrylate and polyethylene glycol (meth)acrylate (PEG (meth)acrylate) having 1 to 8 repeat ethylene glycol units. Preferred alkoxyalkyl esters are polyethylene glycol (meth)acrylate (PEG (meth)acrylate) having 1 to 8 repeat ethylene glycol units and butyl acrylates.

Preferred esters of the α,β-ethylenically unsaturated dicarboxylic acids are, for example,
alkyl monoesters, especially C₄-C₁₈-alkyl monoesters, preferably n-butyl, tert-butyl, n-pentyl or n-hexyl monoesters, more preferably mono-n-butyl maleate, mono-n-butyl fumarate, mono-n-butyl citraconate, mono-n-butyl itaconate;
alkoxyalkyl monoesters, especially C₁-C₁₈-alkoxyalkyl monoesters, preferably C₄-C₁₂-alkoxyalkyl monoesters,
polyethylene glycol esters (PEG) having 1 to 8 repeat ethylene glycol units
hydroxyalkyl monoesters, especially C₄-C₁₈-hydroxyalkyl monoesters, preferably C₄-C₁₂-hydroxyalkyl monoesters,
cycloalkyl monoesters, especially C₅-C₁₈-cycloalkyl monoesters, preferably C₆-C₁₂-cycloalkyl monoesters, more preferably monocyclopentyl maleate, monocyclohexyl maleate, monocycloheptyl maleate, monocyclopentyl fumarate, monocyclohexyl fumarate, monocycloheptyl fumarate, monocyclopentyl citraconate, monocyclohexyl citraconate, monocycloheptyl citraconate, monocyclopentyl itaconate, monocyclohexyl itaconate and monocycloheptyl itaconate,
alkylcycloalkyl monoesters, especially C₆-C₁₂-alkylcycloalkyl monoesters, preferably C₇-C₁₀-alkylcycloalkyl monoesters, more preferably monomethylcyclopentyl maleate and monoethylcyclohexyl maleate, monomethylcyclopentyl fumarate and monoethylcyclohexyl fumarate, monomethylcyclopentyl citraconate and monoethylcyclohexyl citraconate; monomethylcyclopentyl itaconate and monoethylcyclohexyl itaconate;
aryl monoesters, especially C₆-C₁₄-aryl monoesters, preferably monoaryl maleate, monoaryl fumarate, monoaryl citraconate or monoaryl itaconate, more preferably monophenyl maleate or monobenzyl maleate, monophenyl fumarate or monobenzyl fumarate, monophenyl citraconate or monobenzyl citraconate, monophenyl itaconate or monobenzyl itaconate or mixtures thereof,
unsaturated polyalkyl polycarboxylates, for example dimethyl maleate, dimethyl fumarate, dimethyl itaconate or diethyl itaconate; or
α,β-ethylenically unsaturated carboxylic esters containing amino groups, for example dimethylaminomethyl acrylate or diethylaminoethyl acrylate.
   Component (b)—Silane-Coated Wollastonite The vulcanizable composition according to the invention comprises, as component (b), at least one silane-coated wollastonite.

The silanes which are used for coating of the wollastonites are silanes having at least one functionalization that can react with the filler surface and preferably having a second functionalization that, after the vulcanization, binds the modified filler to the polymer matrix, for example vinyl groups.

Preferred silanes are epoxysilane, methacryloylsilane, vinylsilane or aminosilane. Particularly preferred silanes are epoxysilane, methacryloylsilane and vinylsilane. A very particularly preferred silane is vinylsilane.

Compositions comprising rubber, peroxide compound and wollastonite with vinylsilane coating lead to a further improvement in ageing. Vulcanizates comprising vinylsilane-coated wollastonite, after ageing for 1008 hours in G13, have the best balance between change in elongation at break, volume swelling and change in tensile strength, and are thus better than vulcanizates comprising epoxysilane-coated wollastonite or methacryloylsilane-coated wollastonite.

Wollastonites are naturally occurring calcium silicate minerals of the formula CaSiO₃. Wollastonites are white in colour and have a basic pH of greater than 7. The wollastonites used in the examples have an aspect ratio of 3:1 to 5:1. Silane-coated wollastonite is commercially available under the Tremin® brand name from Quarzwerke.

In the compositions according to the invention, based on 100 parts by weight of the rubbers (a), 35 to 150 parts by weight, more preferably 50 to 100 parts by weight, of at least one silane-coated wollastonite are used.

Component (c)—Peroxide Compound

At least one peroxide compound as crosslinking agent is used as component (c).

Suitable peroxide compounds (c) are, for example, the following peroxide compounds:

bis(2,4-dichlorobenzoyl) peroxide, dibenzoyl peroxide, bis(4-chlorobenzoyl) peroxide, 1,1-bis(tert-butylperoxy)-3,3,5-trimethylcyclohexane, tert-butyl perbenzoate, 2,2-bis(tert-butylperoxy)butene, 4,4-di-tert-butyl peroxynonylvalerate, dicumyl peroxide, 2,5-dimethyl-2,5-di(tert-butylperoxy)hexane, tert-butyl cumyl peroxide, 1,3-bis(tert-butylperoxyisopropyl)benzene, di-tert-butyl peroxide, 2,5-dimethyl-2,5-di(tert-butylperoxy)hexyne, tert-butyl hydroperoxide, hydrogen peroxide, methyl ethyl ketone peroxide, lauroyl peroxide, decanoyl peroxide, 3,5,5-trimethylhexanoyl peroxide, di(2-ethylhexyl) peroxydicarbonate, poly(tert-butyl peroxycarbonate), ethyl 3,3-di(tert-butylperoxy)butyrate, ethyl 3,3-di(tert-amylperoxy)butyrate, n-butyl 4,4-di(tert-butylperoxy)valerate, 2,2-di(tert-butylperoxy)butane, 1,1-di(tert-butylperoxy)cyclohexane, 3,3,5-trimethylcyclohexane, 1,1-di(tert-amylperoxy)cyclohexane, tert-butyl peroxybenzoate, tert-butyl peroxyacetate, tert-butyl peroxy-3,5,5-trimethylhexanoate, tert-butyl peroxyisobutyrate, tert-butyl peroxy-2-ethylhexanoate, tert-butyl peroxypivalate, tert-amyl peroxypivalate, tert-butyl peroxyneodecanoate, cumyl peroxyneodecanoate, 3-hydroxy-1,1-dimethylbutyl peroxyneodecanoate, tert-butyl peroxybenzoate, tert-butyl peroxyacetate, tert-amyl peroxy-3,5,5-trimethylhexanoate, tert-butyl peroxyisobutyrate, tert-butyl peroxy-2-ethylhexanoate, cumyl peroxyneodecanoate, 3-hydroxy-1,1-dimethylbutyl peroxyneodecanoate, 2,5-dimethyl-2,5-di(tert-butylperoxy)hexyne 3-di-tert-amyl peroxide, 2,5-dimethyl-2,5-di(tert-butylperoxy)hexane, tert-amyl hydroperoxide, cumene hydroperoxide, 2,5-dimethyl-2,5-di(hydroperoxy)hexane, diisopropylbenzene monohydroperoxide and potassium peroxodisulphate.

The at least one peroxide compound of the vulcanizable composition according to the invention is preferably an organic peroxide, especially dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, tert-butyl perbenzoate, butyl 4,4-di(tert-butylperoxy)valerate and/or 1,1-bis(tert-butylperoxy)-3,3,5-trimethylcyclohexane.

Component (c) is present in the vulcanizable compositions according to the invention preferably in an amount of 1 to 20 parts by weight, more preferably in an amount of 2 to 10 parts by weight, based on 100 parts by weight of the rubbers (a).

In addition, the vulcanizable composition may comprise further rubber additives. Standard rubber additives include, for example: polymers not covered by the inventive definition of component (a), filler-activators, oils, especially processing oils or extender oils, plasticizers, processing auxiliaries, accelerators, multifunctional crosslinkers, ageing stabilizers, antiozonants, antioxidants, mould release agents, retardants, further stabilizers and antioxidants, dyes, fibres comprising organic and inorganic fibres and fibre pulps, vulcanization activators, and additional polymerizable monomers, dimers, trimers or oligomers.

Useful filler-activators include organic silanes in particular, for example vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler-activators are, for example, interface-active substances such as triethanolamine or ethylene glycols with molecular weights of 74 to 10 000 g/mol. The amount of filler-activators is typically 0.5 to 10 parts by weight, based on 100 parts by weight of the rubbers (a).

Useful ageing stabilizers are especially those which scavenge a minimum number of radicals in the peroxidic vulcanization. These are especially oligomerized 2,2,4-trimethyl-1,2-dihydroquinoline (TMQ), styrenized diphenylamine (DDA), octylated diphenylamine (OCD), cumylated diphenylamine (CDPA), 4- and 5-methylmercaptobenzimidazole (MB2) or zinc salt of 4- and 5-methylmercaptobenzimidazole (ZMB2). In addition, it is also possible to use the known phenolic ageing stabilizers, such as sterically hindered phenols, or ageing stabilizers based on phenylenediamine. It is also possible to use combinations of the ageing stabilizers mentioned, preferably CDPA in combination with ZMB2 or MB2, more preferably CDPA with MB2.

The ageing stabilizers are typically used in amounts of 0.1 to 5 parts by weight, preferably of 0.3 to 3 parts by weight, based on 100 parts by weight of the rubbers (a).

Examples of useful mould release agents include: saturated or partly unsaturated fatty acids and oleic acids or derivatives thereof (in the form of fatty acid esters, fatty acid salts, fatty alcohols or fatty acid amides), and also products applicable to the mould surface, for example products based on low molecular weight silicone compounds, products based on fluoropolymers and products based on phenolic resins.

The mould release agents are used as blend component in amounts of 0.2 to 10 parts by weight, preferably 0.5 to 5 parts by weight, based on 100 parts by weight of the rubbers (a).

Reinforcement of the vulcanizates with glass strengthening elements according to the teaching of U.S. Pat. No. 4,826,721 is also possible, as is reinforcement with aromatic polyamides (aramid).

In a preferred embodiment, a vulcanizable composition for production of a vulcanizate in contact with coolant is used, characterized in that the vulcanizable composition comprises
(a) 100 parts by weight of at least one rubber, preferably hydrogenated nitrile rubber,
(b) 35 to 150 parts by weight, preferably 50 to 100 parts by weight, of at least one silane-coated wollastonite, preferably epoxysilane-, methacryloylsilane- or vinylsilane-coated wollastonite or mixtures thereof,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide or aluminium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the rubbers (a),
where the content of zinc ions is less than 1.5 parts by weight based on 100 parts by weight of the rubbers (a) and the vulcanizable composition is preferably free of zinc ions.

Preferred embodiments of this kind have improved hot air ageing after 504 hours at 150° C.

Particularly preferred embodiments are the use of vulcanizable compositions for production of a vulcanizate in contact with coolant and a process for producing a vulcanizate in contact with coolant, comprising the step of vulcanizing a vulcanizable composition comprising
(a) 100 parts by weight of at least one hydrogenated nitrile rubber,
(b) 50 to 85 parts by weight of at least one silane-coated wollastonite,
(c) 2 to 10 parts by weight of at least one peroxide compound, where the composition has a content of zinc ions of less than 1.5 parts by weight based on 100 parts by weight of the rubbers (a).

The invention further provides a process for producing the aforementioned vulcanizable compositions according to the invention, by mixing all components (a), (b) and (c) and optionally (d). This can be effected using apparatuses and mixing units known to those skilled in the art.

The sequence in which the components are mixed with one another is not of fundamental importance, but is matched in each case to the mixing units available and the temperature regime.

The mixing of components (a), (b) and (c) and optionally (d) can be effected here, according to temperature, using the typical mixing systems that are in common use in the rubber industry. It is possible to use i) batchwise mixing units in the form of mixing rolls or internal mixers and ii) continuous mixing units such as mixing extruders.

It has been found to be particularly useful to conduct the mixing of components (a), (b) and (c) and optionally (d) at a defined mixer temperature in the range from about 30 to 40° C., since sufficiently high shear forces can be applied here with the abovementioned mixing units that are in common use in the rubber processing industry to achieve good mixing.

Preferably, the rubber (a) is initially charged and masticated, and then all further components apart from the vulcanization chemicals (peroxide compound and coagent) are added. After an appropriate mixing time, the mixture is discharged. The peroxide compound and the coagent are mixed in in a second step on a roll. The speed of the roll is controlled here such that stable skins are obtained.

In practice, after the components according to the invention have been mixed, the vulcanizable compositions are obtained, for example, in the form of what are called “skins”, feed strips or feed slabs, or else in the form of pellets or granules. These can subsequently be pressed in moulds or injection-moulded and are crosslinked under suitable conditions according to the free-radical donors used.

The invention further provides for the production of vulcanizates by subjecting the aforementioned vulcanizable compositions to a vulcanization, i.e. an input of energy, especially a thermal treatment.

The input of energy can be effected, for example, in the form of thermal energy. The production of the vulcanized products by means of thermal treatment is conducted by subjecting the vulcanizable compositions according to the invention to a temperature in the range from preferably 120 to 200° C., more preferably from 140 to 180° C., in a customary manner, i.e. for a period of one minute to 300 minutes, in suitable moulds. The vulcanization can be brought about with the aid of any method, such as compression vulcanization, steam vulcanization and the like.

In the course of crosslinking of the vulcanizable composition according to the invention, the peroxide compounds (c) lead to free-radical crosslinking between and with the rubbers (a) used.

The invention also further provides the crosslinked rubbers, i.e. vulcanizates, obtainable by crosslinking the aforementioned vulcanizable compositions, and for the use of vulcanizates for production of a component part in contact with coolant.

More particularly, the invention provides for the use of a vulcanizate produced from a vulcanizable composition for production of a component part of which at least the vulcanizate is in contact with coolant, characterized in that the vulcanizable composition comprises
(a) at least one rubber, preferably at least one hydrogenated nitrile rubber or EPDM, more preferably hydrogenated nitrile rubber,
(b) at least one silane-coated wollastonite, preferably at least one vinylsilane-coated wollastonite, and
(c) at least one peroxide compound.

The invention also further provides component parts comprising a vulcanizate in contact with a coolant, produced from a vulcanizable composition, characterized in that the vulcanizable composition comprises

(a) at least one rubber, preferably at least one hydrogenated nitrile rubber or EPDM, more preferably hydrogenated nitrile rubber,
(b) at least one silane-coated wollastonite, preferably at least one vinylsilane-coated wollastonite, and
(c) at least one peroxide compound.

The invention preferably also further provides component parts comprising a vulcanizate in contact with a coolant, produced from a vulcanizable composition, characterized in that the vulcanizable composition comprises
(a) 100 parts by weight of hydrogenated nitrile rubber,
(b) 50 to 85 parts by weight of an epoxysilane-, methacryloylsilane- or vinylsilane-coated wollastonite or mixtures thereof,
(c) 2 to 10 parts by weight of at least one peroxide compound,
where the content of zinc ions is less than 1.5 parts by weight based on 100 parts by weight of the rubbers (a).

Preferably, these component parts are seals, cooler seals, hoses, cooler hoses, motor vehicle cooling water hoses, heating hoses and cooler housings.

The invention thus also provides processes for producing a component part in contact with coolant, comprising the step of vulcanizing a vulcanizable composition according to the invention and contacting with coolant.

The vulcanizates obtained by the vulcanizing of the vulcanizable composition can be processed by a customary method to give a cooler hose, a heating hose, a cooler housing, a cooler seal or the like, and these products are particularly excellent products having the above-described properties. More particularly, vulcanizates of this kind have improved ageing stability.

The invention further provides for the use of a vulcanizable composition for production of a vulcanizate in contact with coolant, characterized in that the vulcanizable composition comprises

(a) at least one rubber, preferably at least one hydrogenated nitrile rubber or EPDM, more preferably hydrogenated nitrile rubber,
(b) at least one silane-coated wollastonite, preferably at least one vinylsilane-coated wollastonite, and
(c) at least one peroxide compound.

The invention further provides for the use of an aforementioned vulcanizable composition for production of a vulcanizate in contact with coolant, characterized in that the at least one rubber (a) is at least one hydrogenated nitrile rubber which is a fully or partly hydrogenated co- or terpolymer based on at least one conjugated diene and at least one α,β-unsaturated nitrile monomer and optionally further copolymerizable monomers.

The invention further provides for the use of an aforementioned vulcanizable composition for production of a vulcanizate in contact with coolant, characterized in that the at least one rubber (a) is at least one hydrogenated nitrile rubber where the Mooney viscosity (ML 1+4 @ 100C) is in the range from 10 to 120 MU, preferably in the range from 15 to 100 MU, where the Mooney viscosity is determined according to ASTM Standard D1646.

The invention further provides for the use of an aforementioned vulcanizable composition for production of a vulcanizate in contact with coolant, characterized in that the amount of the at least one silane-coated wollastonite (b) is 35 to 150 parts by weight, preferably 50 to 100 parts by weight, based on 100 parts by weight of the rubbers (a).

The invention further provides for the use of an aforementioned vulcanizable composition for production of a vulcanizate in contact with coolant, characterized in that the at least one peroxide compound (c) is an organic peroxide, preferably dicumyl peroxide, t-butyl cumyl peroxide, bis(t-butylperoxyisopropyl)benzene, di-t-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, t-butyl perbenzoate, butyl 4,4-di(t-butylperoxy)valerate or 1,1-bis(t-butylperoxy)-3,3,5-trimethylcyclohexane.

The invention further provides for the use of an aforementioned vulcanizable composition for production of a vulcanizate in contact with coolant, characterized in that a further component (d) used is at least one filler which is a carbon black or a mineral filler, preferably a basic mineral filler.

The invention further provides for the use of an aforementioned vulcanizable composition for production of a vulcanizate in contact with coolant, characterized in that a component (d) used is at least one ageing stabilizer selected from the group consisting of diphenylamine, mercaptobenzimidazole, substituted phenols and mixtures thereof.

The invention further provides for the use of an aforementioned vulcanizable composition for production of a vulcanizate in contact with coolant, characterized in that the composition comprises

(a) 100 parts by weight of at least one rubber, preferably at least one hydrogenated nitrile rubber or EPDM, more preferably hydrogenated nitrile rubber,
(b) 35 to 150 parts by weight, preferably 50 to 100 parts by weight, of at least one silane-coated wollastonite, preferably at least one vinylsilane-coated wollastonite,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide or aluminium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the rubbers (a).

The invention further provides for the use of an aforementioned vulcanizable composition for production of a vulcanizate in contact with coolant, characterized in that the vulcanizable composition comprises

(a) 100 parts by weight of at least one rubber, preferably hydrogenated nitrile rubber,
(b) 35 to 150 parts by weight, preferably 50 to 100 parts by weight, of at least one silane-coated wollastonite, preferably epoxysilane-, methacryloylsilane- or vinylsilane-coated wollastonite or mixtures thereof,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide or aluminium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the rubbers (a),
where the content of zinc ions is less than 1.5 parts by weight based on 100 parts by weight of the rubbers (a) and the vulcanizable composition is preferably free of zinc ions.

The invention further provides for the use of a vulcanizate produced from an aforementioned vulcanizable composition for producing a component part of which at least the vulcanizate is in contact with coolant.

The invention further provides for the use of a vulcanizate produced from an aforementioned vulcanizable composition, characterized in that the component part is a hose, a heating hose, a cooling hose, a seal or a cooling seal.

The invention further provides for the use of an aforementioned vulcanizable composition for production of a vulcanizate in contact with coolant, wherein the coolant comprises water, a freezing point depressant, preferably alkylglycol or salts, more preferably ethylene glycol or propylene glycol, and a corrosion inhibitor, preferably neutralized organic acids, more preferably sodium ethylhexanoate.

The invention thus further provides for the use of 35 to 150 parts by weight of silane-coated wollastonite, preferably vinylsilane-coated wollastonite, based on 100 parts by weight of the rubbers (a), in a vulcanizable composition comprising at least one rubber (a) and at least one peroxide compound (c) for improving the ageing stability in hot air after 21 days at 150° C. and in coolant after 21 days at 150° C. of vulcanizates in contact with coolants, produced by vulcanization of the vulcanizable composition, preferably at 120 to 200° C.

The basic production of such seals and hoses is known to those skilled in the art. For the production of belts, the person skilled in the art can proceed using the vulcanizable compositions according to the invention, for example, analogously to the disclosure of U.S. Pat. No. 4,715,607.

The invention further provides cooling units having i) at least one vulcanizate produced from a vulcanizable mixture comprising the aforementioned components (a), (b) and (c) and ii) coolant. Examples of such cooling units are cooling devices for motor vehicles.

The invention thus further provides vulcanizable compositions comprising

(a) 100 parts by weight of hydrogenated nitrile rubber,
(b) 50 to 100 parts by weight of an epoxysilane-, methacryloylsilane- or vinylsilane-coated wollastonite or mixtures thereof,
(c) 2 to 10 parts by weight of at least one peroxide compound,
where the content of zinc ions is less than 1.5 parts by weight based on 100 parts by weight of the rubbers (a).

### EXAMPLES

### Production, Vulcanization and Characterization of the Compositions

Examples 7* and 8* which follow are non-inventive comparative examples, and Examples 1 to 6 and 9 are inventive examples. The comparative examples are identified in the tables which follow by an * after the example number.

The primary mixing unit used was an internal mixer of the GK 1.5 E type (manufacturer: HF Mixing Group). The speed was 40 min⁻¹, the cooling water inlet temperature 40° C.

This involved masticating the initial charge of the rubber (a) for 1 minute, then adding all further components apart from the vulcanization chemicals (peroxide compound and coagent). 3 minutes after commencement of mixing, the plunger was pulled out and brushed. After a mixing time of 250 seconds, the mixture was discharged.

The peroxide compound and the coagent were mixed in in a second step at 30° C. on a roll (manufacturer: Tröster, roll diameter 20 cm). The friction was 1:1.11.

The speed of the roll was controlled here such that stable skins were obtained.

Subsequently, vulcanization of these skins was undertaken in slab presses at 180° C. for 15 min.

### Components Used:

| | |
|---|---|
| Therban ® | hydrogenated nitrile rubber, ACN content: 39% by |
| 3907 | weight, Mooney viscosity ML 1 + 4 @100° C.: 70 MU, |
| | residual double bond content: max. 0.9%. This rubber is |
| | commercially available from ARLANXEO Deutschland |
| | GmbH. |
| Therban ® | hydrogenated nitrile rubber, ACN content: 34% by |
| 3407 | weight, Mooney viscosity ML 1 + 4 @100° C.: 70 MU, |
| | residual double bond content: max. 0.9%, available from |
| | ARLANXEO Deutschland GmbH. |
| Therban ® | hydrogenated acrylate-comprising nitrile rubber, CAN |
| LT 1707 VP | content: 17% by weight, Mooney viscosity ML 1 + 4 |
| | @100° C.: 74 MU, residual double bond content: max. |
| | 0.9%, available from ARLANXEO Deutschland GmbH. |
| Tremin ® | epoxysilane-coated wollastonite, available from |
| 283-600 EST | Quarzwerke |
| Tremin ® | methacryloylsilane-coated wollastonite, available from |
| 283-600 MST | Quarzwerke |
| Tremin ® | vinylsilane-coated wollastonite, available from |
| 283-600 VST | Quarzwerke |
| N550 | Corax ® N 550 carbon black; available from Orion |
| | Engineered Carbon |
| N774 | Corax ® N 774 carbon black; available from Orion |
| | Engineered Carbon |
| N990 | Luvomaxx MT N-990 carbon black; available from |
| | Lehmann and Voss |
| Luvomaxx ® | 4,4′-bis(1,1-dimethylbenzyl)diphenylamine, available |
| CDPA | from Lehmann and Voss |
| Vulkanox ® | 4- and 5-methyl-2-mercaptobenzimidazole; available |
| MB2 | from Lanxess Deutschland GmbH |
| Vulkanox ® | zinc salt of 4- and 5-methyl-2-mercaptobenzothiazole; |
| ZMB2/C5 | available from LANXESS Deutschland GmbH |
| Maglite ® DE | magnesium oxide, available from CP Hall. |
| Active zinc | zinc oxide (ZnO), commercially available from |
| oxide | LANXESS Deutschland GmbH |
| TAIC 70% | KETTLITZ-TAIC 70; coagent; available from Kettlitz- |
| | Chemie GmbH & Co. KG |
| TOTM | Uniplex ® 546; available from Rheinchemie Rheinau |
| | GmbH |
| Rhenofit ® | 70% trimethylolpropane trimethacrylate on 30% silica; |
| TRIM/S | coagent; available from Rhein Chemie Rheinau GmbH |
| Perkadox ® | di(tert-butylperoxyisopropyl)benzene 40% supported on |
| 14-40 | silica, available from Akzo Nobel Polymer Chemicals BV |
| G13/water | G13 coolant additive available from Volkswagen; for the |
| mixture | storage tests, 50 parts by volume of deionized water |
| | and 50 parts by volume of G13 coolant additive were |
| | mixed |
| G64/water | Glysantin ® G64 coolant additive based on ethylene |
| mixture | glycol available from BASF; for the storage tests 50 |
| | parts by volume of deionized water and 50 parts by |
| | volume of Glysantin ® G64 coolant additive were mixed |
| 2-Ethyl- | available from Sigma Aldrich |
| hexanoic | |
| acid | |
| Ethylene | available from Sigma Aldrich |
| glycol | |

The amounts in part by weight stated in the examples are based on 100 parts by weight of the rubber (a).

The MDR (moving die rheometer) vulcanization profile and analytical data associated therewith were measured in a Monsanto MDR 2000 rheometer in accordance with ASTM D5289-95.

The tensile tests for determining the strain as a function of deformation were carried out in accordance with DIN 53504 or ASTM D412-80.

The Shore A hardness was measured in accordance with ASTM-D2240-81.

The hot air ageing was conducted in accordance with DIN 53508/2000. The method 4.1.1 “Storage in a heating cabinet with positive ventilation” was applied.

The storage tests in the G13/water mixture were effected in pressure vessels with a ratio of liquid to specimen of 150:1.

TABLE 1
Composition of the vulcanizable compositions

| | Examples | | | | | | | | |
|---|---|---|---|---|---|---|---|---|---|
| | 1 | 2 | 3 | 4 | 5 | 6 | 7* | 8* | 9 |
| | [parts by weight] | | | | | | | | |
| Therban ® 3907 | 100 | 100 | 100 | 100 | 100 | 100 | 100 | | |
| Therban ® 3407 | | | | | | | | 100 | 100 |
| Tremin ® 283-600 EST | 65 | | | 65 | 65 | 65 | | | 65 |
| Tremin ® 283-600 MST | | 65 | | | | | | | |
| Tremin ® 283-600 VST | | | 65 | | | | | | |
| N550 | | | | | | | | 50 | |
| N774 | 14 | 14 | 14 | 15 | 15 | 15 | 15 | | 15 |
| N990 | | | | | | | 65 | | |
| Luvomaxx ® CDPA | 1.5 | 1.5 | 1.5 | 1.5 | 1.5 | 1.5 | 1.5 | 1.1 | 1.5 |
| Vulkanox ® MB2 | 0.3 | 0.3 | 0.3 | | | 0.3 | 0.3 | 0.3 | 0.3 |
| Vulkanox ® ZMB2 | | | | 0.4 | 0.4 | | | | |
| Maglite ® DE | 3 | 3 | 3 | 3 | 3 | 3 | 3 | | |
| Active zinc oxide | | | | 3 | | | | | |
| TAIC 70% | | | | | | | | 1.5 | |
| TOTM | 5 | | | | | | | | 5 |
| Rhenofit ® TRIM/S | 1.5 | 1.5 | 1.5 | 1.5 | 1.5 | 1.5 | 1.5 | | 3 |
| Perkadox ® 14-40 | 8 | 8 | 8 | 7.5 | 7.5 | 7.5 | 7.5 | 8 | 7.5 |

The vulcanizable composition of Example 7* serves as a comparative experiment for Examples 1 to 6, since it does not contain any silane-coated wollastonite (Tremin®). The amount of 65 parts by weight of wollastonite based on 100 parts by weight of HNBR in Examples 1 to 6 was compensated for by the filler N990 in Example 7*. The vulcanizable composition of Example 8* serves as a comparative experiment for Example 9, since it does not contain any silane-coated wollastonite (Tremin®). The amount of 65 parts by weight of wollastonite in Example 9 was compensated for in Example 8* by 50 parts by weight of the filler N550 in order to attain similar tensile strength values. Significantly less N550 than Tremin® is required to obtain similar hardness and tensile strength.

Vulcanization was measured in a Monsanto MDR 2000 rheometer at a test temperature of 180° C. over a test duration of 15 min.

TABLE 2
Vulcanization characteristics of the vulcanizable compositions

| MDR at 180° C. | | 1 | 2 | 3 | 4 | 5 | 6 | 7* | 8* | 9 |
|---|---|---|---|---|---|---|---|---|---|---|
| S′ min | dNm | 1.37 | 1.36 | 1.38 | 1.43 | 1.47 | 1.46 | 1.85 | 2.21 | 1.38 |
| S′ max | dNm | 24.73 | 24.77 | 25.34 | 23.75 | 23.35 | 22.76 | 27.57 | 30.04 | 20.49 |
| Delta S′ | dNm | 23.36 | 23.41 | 23.96 | 22.32 | 21.88 | 21.3 | 25.72 | 27.83 | 19.11 |
| TS 1 | s | 31 | 31 | 31 | 33 | 33.6 | 33.6 | 29.4 | 28 | 37 |
| TS 2 | s | 37 | 37 | 37 | 39.6 | 40.2 | 40.8 | 36 | 34 | 46 |
| t 50 | s | 94 | 94 | 94 | 98.49 | 95.8 | 97.03 | 95.7 | 113 | 107 |
| t 90 | s | 268 | 266 | 267 | 294 | 271 | 271 | 270.54 | 324 | 298 |
| t 95 | s | 346 | 342 | 344 | 387 | 350 | 348 | 349.92 | 418 | 387 |

S′ min is the minimum torque of the crosslinking isotherm
S′ max is the maximum torque of the crosslinking isotherm
Delta S′ difference of S′max and S′min
t 50: time at which 50% of the final conversion has been attained
t 90: time at which 90% of the final conversion has been attained
t 95: time at which 95% of the final conversion has been attained

The series of experiments shows that the compositions produced in accordance with the invention (1 to 6) have vulcanization characteristics comparable to the comparative example (7*). The inventive rubber mixture (9) likewise has vulcanization characteristics comparable to the comparative example (8*).

The vulcanizable compositions were subsequently vulcanized in a slab press under a pressure of 170 bar at 180C for 10 min.

The test values reported in Table 3 were determined at 23° C. on the vulcanizates that had been heat-treated at 160° C. for 4 hours.

TABLE 3
Properties of the vulcanized compositions 1 to 9 after vulcanization
(10 minutes) at 180° C. (test temperature: 23° C.)

| | | | | | | | | | |
|---|---|---|---|---|---|---|---|---|---|
| Tensile test | 1 | 2 | 3 | 4 | 5 | 6 | 7* | 8* | 9 |

2 mm slabs vulcanized at 180° C. for 10 min

| | | | | | | | | | | |
|---|---|---|---|---|---|---|---|---|---|---|
| M 10 | MPa | 0.8 | 0.9 | 0.8 | 0.8 | 0.8 | 0.8 | 0.8 | 0.7 | 0.7 |
| M 25 | MPa | 1.5 | 1.7 | 1.4 | 1.4 | 1.3 | 1.4 | 1.4 | 1.3 | 1.2 |
| M 50 | MPa | 2.4 | 3.3 | 2.6 | 2.1 | 2 | 2 | 2.2 | 2.2 | 1.8 |
| M 100 | MPa | 4.3 | 8.1 | 7.1 | 3.5 | 3.3 | 3.3 | 5.1 | 6.2 | 2.6 |
| M 300 | MPa | 10.9 | 17.5 | 19.8 | 9 | 8.9 | 8.7 | 17.6 | — | 7.8 |
| EB | % | 441 | 310 | 300 | 466 | 458 | 467 | 363 | 249 | 468 |
| TS | MPa | 27 | 18 | 20 | 24 | 24 | 24 | 18 | 25.5 | 24.3 |
| H | ShA | 68 | 69 | 69 | 66 | 66 | 65 | 70 | 71 | 61.8 |

The unaged comparative vulcanizate 7* has lower elongation at break and tensile strength than the inventive vulcanizates 4 to 6.

The unaged comparative vulcanizate 8* has significantly lower elongation at break coupled with the same tensile strength as the inventive vulcanizate 9.

The two comparative vulcanizates have a hardness (H) of 70 or more, whereas the inventive vulcanizates 1 to 6 and 9 have a hardness of less than 70.

TABLE 4
Properties of the vulcanized compositions 1 to 7 after hot air ageing at
150° C./504 h (test temperature: 23° C.)

| | | | | | | | |
|---|---|---|---|---|---|---|---|
| Tensile test | 1 | 2 | 3 | 4 | 5 | 6 | 7* |

Ageing of the vulcanizates in hot air, 504 h at 150° C.

| | | | | | | | | |
|---|---|---|---|---|---|---|---|---|
| M 10 | MPa | 1.2 | 1.2 | 1.1 | 1.2 | 1.2 | 1.2 | 1.3 |
| M 25 | MPa | 2.4 | 2.6 | 2.3 | 2.5 | 2.5 | 2.5 | 2.5 |
| M 50 | MPa | 4.9 | 5.5 | 5 | 5 | 5 | 5 | 4.8 |
| M 100 | MPa | 8.6 | 10.9 | 10.9 | 9.2 | 9 | 9 | 10.4 |
| M 300 | MPa | 14.1 | 16.4 | — | 14.1 | 13.7 | 13.6 | — |
| EB | % | 375 | 233 | 254 | 383 | 396 | 429 | 228 |
| TS | MPa | 18 | 15.4 | 17.1 | 17.5 | 17.4 | 19.4 | 18.5 |
| H | ShA | 76 | 76 | 76 | 76 | 76 | 76 | 80 |

TABLE 5
Change in the properties of the vulcanized compositions 1 to 7 after
hot air ageing at 150° C./504 h (test temperature: 23° C.)

| | | | | | | | |
|---|---|---|---|---|---|---|---|
| Change | 1 | 2 | 3 | 4 | 5 | 6 | 7* |

Ageing of the vulcanizates in hot air, 504 h at 150° C.

| | | | | | | | | |
|---|---|---|---|---|---|---|---|---|
| Δ EB | % | −15 | −25 | −15 | −18 | −14 | −8 | −37 |
| Δ TS | % | −33 | −13 | −14 | −28 | −28 | −18 | 2 |
| Δ H | ShA | 8 | 8 | 7 | 10 | 11 | 11 | 10 |

Elongation at break (EB) in the case of comparative experiment 7 without silane-coated wollastonite is an inadequate value with a change of −37% after ageing in hot air for 504 hours. By contrast, the vulcanizates with silane-coated wollastonite of Examples 1 to 6 have a much smaller and hence better drop in elongation at break. The hardness (H) of the inventive examples is comparable with Comparative Example 7.

Example 6 with EST-coated wollastonite and without zinc has the smallest value with a change of −8% in elongation at break and hence gives the best hot air ageing.

TABLE 6
Properties of vulcanized compositions 8 and 9 and change
therein after ageing in ethylene glycol/water/2-ethylhexanoic
acid at 120° C./504 h (test temperature: 23° C.)

| | | Tensile test | |
|---|---|---|---|
| | | 8* | 9 |
| Ageing of the vulcanizates in ethylene | | | |
| glycol/water/2-ethylhexanoic acid, 504 h at 120° C. | | | |
| M 10 | MPa | 0.5 | 0.4 |
| M 25 | MPa | 1 | 0.7 |
| M 50 | MPa | 2.1 | 0.9 |
| M 100 | MPa | 7.4 | 1.3 |
| M 300 | MPa | — | 6 |
| EB | % | 190 | 466 |
| ΔEB | % | −24 | 0 |
| TS | MPa | 18.8 | 19 |
| ΔTS | % | −26 | −22 |
| H | ShA | 57 | 47 |
| ΔH | ShA | | −15 |
| ΔV | % | 47.1 | 19.1 |

Inventive Example 9 with silane-coated wollastonite, compared to Comparative Example 8* without silane-coated wollastonite, has a distinct improvement in elongation at break after ageing for 504 hours in an ethylene glycol/water/2-ethylhexanoic acid mixture.

In addition, Inventive Example 9 has improved swelling (AV).

TABLE 7
Comparison of the coatings—properties of vulcanized
compositions 1 to 3 after ageing at 150° C./1008 h in
G13/water mixture (test temperature: 23° C.)

| Tensile test | | |
|---|---|---|
| 1 | 2 | 3 |

Ageing of the vulcanizates in G13, 1008 h at 150° C.

| | | | | |
|---|---|---|---|---|
| M 10 | MPa | 0.8 | 1 | 1 |
| M 25 | MPa | 1.4 | 1.7 | 1.8 |
| M 50 | MPa | 1.8 | 2.6 | 2.9 |
| M 100 | MPa | 2.6 | 4.5 | 5.5 |
| M 300 | MPa | 6.9 | 8.4 | 11.3 |
| EB | % | 414 | 467 | 381 |
| TS | MPa | 12.1 | 13.6 | 13.2 |
| H | ShA | 71 | 70 | 72 |

TABLE 8
Comparison the properties of vulcanized of the
coatings—change in compositions 1 to 3 after
ageing at 150° C./1008 h in G13/water mixture
(test temperature: 23° C.)

| Change | | |
|---|---|---|
| 1 | 2 | 3 |

Ageing of the vulcanizates in G13, 1008 h at 150° C.

| | | | | |
|---|---|---|---|---|
| Δ EB | % | −6 | 51 | 27 |
| Δ TS | % | −55 | −23 | −33 |
| Δ H | ShA | 3 | 2 | 3 |
| Δ V | % | 19 | 20 | 10 |

Vulcanizates comprising VST-coated wollastonite, after ageing for 1008 hours in G13, have the best balance between change in elongation at break, volume swelling and change in tensile strength, and are thus better than vulcanizates comprising epoxysilane-coated wollastonite or methacryloylsilane-coated wollastonite.

TABLE 9
Properties of vulcanized compositions 4 to 7 after
ageing at 150° C./504 h in G13/water
mixture (test temperature: 23° C.)

| Tensile test | | | |
|---|---|---|---|
| 4 | 5 | 6 | 7* |

Ageing of the vulcanizates in G13, 504 h at 150° C.

| | | | | | |
|---|---|---|---|---|---|
| M 10 | MPa | 1.1 | 0.9 | 0.9 | 0.9 |
| M 25 | MPa | 1.9 | 1.6 | 1.6 | 1.5 |
| M 50 | MPa | 3 | 2.5 | 2.4 | 2.3 |
| M 100 | MPa | 5.2 | 4.1 | 3.9 | 4.8 |
| M 300 | MPa | 11 | 9.2 | 8.7 | 16 |
| EB | % | 466 | 475 | 485 | 432 |
| TS | MPa | 25.4 | 23.6 | 24.5 | 17.4 |
| H | ShA | 72 | 69 | 68 | 72 |

TABLE 10
Change in the properties of vulcanized compositions
4 to 7* after ageing at 150° C./504 h in G13/
water mixture (test temperature: 23° C.)

| Change | | | |
|---|---|---|---|
| 4 | 5 | 6 | 7* |

Ageing of the vulcanizates in G13, 504 h at 150° C.

| | | | | | |
|---|---|---|---|---|---|
| Δ EB | % | 0 | 4 | 4 | 19 |
| Δ TS | % | 5 | −2 | 4 | −4 |
| Δ H | ShA | 6 | 3 | 3 | 2 |
| Δ V | % | 3 | 3 | 3 | 1 |

Comparative Example 7*, with a change in elongation at break of 19% after ageing for 504 hours in G13, has the highest and hence worst value. Inventive Examples 4 to 6 have a distinctly smaller change in elongation at break.

TABLE 11
Composition of the
vulcanizable composition 10

| | Example |
|---|---|
| | 10 |
| Therban ® LT 1707 VP | 100 |
| Tremin ® 283-600 VST | 35 |
| N990 | 50 |
| Luvomaxx ® CDPA | 1.5 |
| Vulkanox ® ZMB2 | 0.3 |
| Maglite ® DE | 3 |
| Rhenofit ® TRIM/S | 1.5 |
| Perkadox ® 14-40 | 9 |

Vulcanization was measured in a Monsanto MDR 2000 rheometer at a test temperature of 180° C. over a test duration of 20 min.

TABLE 12
Vulcanization characteristics
of the vulcanizable composition 10

| | | MDR 180° C. |
|---|---|---|
| | | 10 |
| S′ min | dNm | 1.59 |
| S′ max | dNm | 18.47 |
| Delta S′ | dNm | 16.88 |
| TS 1 | s | 36 |
| TS 2 | s | 45 |
| t 50 | s | 109 |
| t 90 | s | 310 |
| t 95 | s | 395 |
| S′@t 90 | dNm | 16.78 |
| t@S′ max | s | 864 |

TABLE 13
Properties of the vulcanized composition
10 after vulcanization (10 minutes)
at 180° C. (test temperature: 23° C.)

Tensile test
10

2 mm slabs vulcanized at
180° C. for 10 min

| | | |
|---|---|---|
| M 10 | MPa | 0.9 |
| M 25 | MPa | 1.7 |
| M 50 | MPa | 3.3 |
| M 100 | MPa | 8.1 |
| M 300 | MPa | 17.5 |
| EB | % | 310 |
| TS | MPa | 18 |
| H | ShA | 69 |

The vulcanizate has a hardness of less than 70.

TABLE 14
Properties of the vulcanized composition
10 after hot air ageing at
150° C./504 h (test temperature: 23° C.)

| | | Tensile test |
|---|---|---|
| | | 10 |
| M 10 | MPa | 1 |
| M 25 | MPa | 2.2 |
| M 50 | MPa | 4.4 |
| M 100 | MPa | 7.7 |
| M 300 | MPa | — |
| EB | % | 246 |
| TS | MPa | 11.2 |
| H | ShA | 74 |

TABLE 15
Change in the properties of the vulcanized
composition 10 after hot air ageing at
150° C./504 h (test temperature: 23° C.)

| | | Change |
|---|---|---|
| | | 10 |
| Δ EB | % | −12 |
| Δ TS | % | −6.7 |
| Δ H | ShA | 13 |

TABLE 16
Properties of vulcanized composition 10 and
change therein after ageing in Glysantin G64/
water at 150° C./504 h (test temperature: 23° C.)

| | | Tensile test |
|---|---|---|
| | | 10 |
| M 10 | MPa | 1.9 |
| M 25 | MPa | 3.6 |
| M 50 | MPa | 6 |
| M 100 | MPa | 9.1 |
| M 300 | MPa | 13.4 |
| EB | % | 289 |
| ΔEB | % | 4 |
| TS | MPa | 13.7 |
| ΔTS | % | 14.2 |
| H | ShA | 78 |
| ΔH | ShA | 17 |
| ΔV | % | 3.5 |

Vulcanizates based on hydrogenated acrylate-comprising nitrile rubber comprising VST-coated wollastonite have a small change of elongation break of −12% after hot air aging and a small change of elongation break of 4% after aging in coolant (G64/water).

1. A process for producing a vulcanizate for use in contact with coolant, the process comprising vulcanizing a vulcanizable composition comprising:
(a) at least one rubber,
(b) at least one silane-coated wollastonite, and
(c) at least one peroxide compound.

2. The process according to claim 1, wherein the at least one rubber (a) is at least one hydrogenated nitrile rubber comprising a fully or partly hydrogenated co- or terpolymer based on at least one conjugated diene and at least one α,β-unsaturated nitrile monomer and optionally further copolymerizable monomers.

3. The process according to claim 1, wherein the at least one rubber (a) is at least one hydrogenated nitrile rubber having a Mooney viscosity (ML 1+4@100° C.) of 10 to 120 MU, where the Mooney viscosity is determined according to ASTM Standard D1646.

4. The process according to claim 1, wherein the composition comprises 35 to 150 parts by weight of the at least one silane-coated wollastonite (b), based on 100 parts by weight of the rubbers (a).

5. The process according to claim 1, wherein the at least one peroxide compound (c) is an organic peroxide.

6. The process according to claim 1, at least one filler which is a carbon black or a mineral filler.

7. The process according to claim 1, further comprising at least one ageing stabilizer selected from the group consisting of diphenylamine, mercaptobenzimidazole, substituted phenols and mixtures thereof.

8. The process according to claim 1, wherein the composition comprises:
(a) 100 parts by weight of the at least one rubber,
(b) 35 to 150 parts by weight of at least one silane-coated wollastonite
(c) 1 to 20 parts by weight of the at least one peroxide compound, and
(d) 0 to 100 parts by weight, of one or more customary rubber additives.

9. The process according to claim 1, wherein the vulcanizable composition comprises;
(a) 100 parts by weight of at least one of hydrogenated nitrile rubber and EPDM,
(b) 50 to 100 parts by weight of at least one vinylsilane-coated wollastonite,
(c) 2 to 10 parts by weight, of at least one organic peroxide, and
(d) 1 to 80 parts by weight, of one or more customary rubber additives, based on 100 parts by weight of the rubbers (a),
where the composition has a content of zinc ions that is less than 1.5 parts by weight based on 100 parts by weight of the rubbers (a).

10. A vulcanizable composition comprising;
(a) 100 parts by weight of hydrogenated nitrile rubber,
(b) 50 to 85 parts by weight of an epoxysilane-, methacryloylsilane- or vinylsilane-coated wollastonite or mixtures thereof, and
(c) 2 to 10 parts by weight of at least one peroxide compound, and
the composition has a zinc ion content of less than 1.5 parts by weight based on 100 parts by weight of the rubbers (a).

11. A component part comprising a vulcanizate usable in contact with a coolant, the vulcanizate comprising a vulcanizable composition comprising:
(a) at least one rubber,
(b) at least one silane-coated wollastonite, and
(c) at least one peroxide compound.

12. A process for producing a component in contact with coolant, the process comprising vulcanizing the vulcanizable composition as defined in claim 1 10 to produce a vulcanized component, and contacting the component with coolant.

13. The process according to claim 12, wherein the component is a hose, a heating hose, a cooling hose, a seal, or a cooling seal.

14. The process according to claim 12, wherein the coolant comprises water, a freezing point depressant, and a corrosion inhibitor.

15. A cooling unit comprising:
(i) at least one component according to claim 11, and
(ii) coolant,
wherein the at least one vulcanizate is in contact with the coolant ii).

16. The process according to claim 14, wherein the freezing point depressant is ethylene glycol or propylene glycol, and the corrosion inhibitor Is sodium ethylhexanoate.

17. The process according to claim 1, wherein the composition comprises:
100 parts by weight of at least one fully or partly hydrogenated nitrile rubber comprising a fully or partly hydrogenated co- or terpolymer based on at least one conjugated diene and at least one α,β-unsaturated nitrile monomer, and having a Mooney viscosity of 15 to 100 MU (ML1+4)@100° C.;
50 to 100 parts by weight of at least one silane-coated wollastonite selected from the group consisting of epoxysilane-coated wollastonite, methacryloylsilane-coated wollastonite, and vinylsilane-coated wollastonite;
2 to 10 parts by weight, of at least one organic peroxide selected from the group consisting of dicumyl peroxide, t-butyl cumyl peroxide, bis(t-butylperoxysopropyl)benzene, di-t-butyl peroxide, 2,5-dimethylhexane 2,5-dihydroperoxide, 2,5-dimethythex-3-yne 2,5-dihydroperoxide, dibenzoyl peroxide, bis(2,4-dichlrobenzoyl) peroxide, t-butyl perbenzoate, butyl 4,4-di(t-butylperoxy)valerate and 1,1-bis(t-butylperoxy)-3,3,5-trimethylcyclohexane; and
1 to 80 parts by weight, of one or more rubber additives selected from the group consisting of:
filers selected from the group consisting of carbon black, silica, magnesium oxide, aluminium oxide,
filler-activators based on an organic silane,
ageing stabilizers selected from the group consisting of oligomerized 2,2,4-trimethyl-1,2-dihydroquinoline (TMQ), styrenized diphenylamine (DDA), octylated diphenylamine (OCD), cumylated diphenylamine (CDPA), zinc salt of 4- and 5-methylmercaptobenzimidazole (Vulkanox ZMB2), and zinc salt of 4- and 5-methylmercaptobenzimidazole,
mould release agents, and
processing aids,
based on 100 parts by weight of the rubbers (a), and
the composition is free of zinc ions.
